(19) United States
(12) Patent Application Publication
(10) Pub. No.: US 2015/0348311 A1
(43) Pub. Date: Dec. 3, 2015

(54) METHOD AND APPARATUS FOR DETERMINING A SURFACE TOPOGRAPHY OF A BODY IN A COORDINATE SYSTEM FIXED IN SPACE AND/OR FIXED ON THE BODY

(71) Applicant: Carl Zeiss Meditec AG, Jena (DE)

(72) Inventors: Stefan Saur, Aalen (DE); Marco Wilzbach, Stuttgart (DE); Gerald Panitz, Ellwangen (DE)

(21) Appl. No.: 14/723,208

(22) Filed: May 27, 2015

(30) Foreign Application Priority Data
May 27, 2014 (DE) 10 2014 210 051.8

(51) Int. Cl. G06T 15/08; G06T 17/20; G06T 7/00

(52) U.S. Cl. CPC G06T 15/08; G06T 7/0036; G06T 7/0038; G06T 17/20; G06T 2215/12; G06T 2215/16; G06T 2207/10012; G06T 2207/10028; G06T 2207/10056; G06T 2207/20048; G06T 2207/30204; G06T 2207/30196; G06T 2207/30244

(57) ABSTRACT

A method for determining a surface topography of a body includes the following steps: recording a stereoscopic image of the surface of the body with an image recording device; and, generating a topography data set from the stereoscopic image in a coordinate system set by the image recording device. The invention further relates to apparatuses for determining a surface topography of a body in a coordinate system fixed in space and/or a coordinate system fixed on the body.

### CROSS REFERENCE TO RELATED APPLICATION

This application claims priority of German patent application no. 10 2014 210 051.8, filed May 27, 2014, the entire content of which is incorporated herein by reference.

### FIELD OF THE INVENTION

The invention relates to a method and an apparatus for determining a surface topography of a body in a coordinate system fixed in space and/or fixed on the body.

### BACKGROUND OF THE INVENTION

In many applications, particularly medical engineering, it is necessary to compare data sets for the same body or body part, which were recorded at different times and possibly with different devices, or to bring these into correspondence in terms of their spatial or planar orientation. This process is also known by the term “registration”. Here, in a first step, data of a body or a body part of a patient are acquired using a first device, for example, a computed tomography or nuclear magnetic resonance imaging scanner or, in general, an imaging device, and stored in a first data set, which is defined in a coordinate system set by the first device. In medical engineering, this first step is often performed on the patient prior to actual operation. In a second step, following in time and often performed during an operation, a second data set of the same body or body part is established with a second device in a coordinate system that is fixed by the second device. Here, the second device can be identical to the first device or differ functionally from the first device and, in particular, be configured as a camera or an OCT (optical coherence tomography) device. Since the position of the body or the body part relative to the first device during the first step generally differs from the position of the body or body part relative to the second device during the second step, it is often necessary to bring the data set obtained in the first step into correspondence with the data set obtained in the second step in respect of its planar or spatial position and orientation.

The prior art has disclosed, for registration purposes, the practice of sticking markers onto the body part to be examined, which markers remain on the patient during the first step and the second step. The position of the markers in space is acquired during the first and the second step by a suitable camera system and stored with the first and the second data set. A transformation prescription, on the basis of which the patient data sets can be converted into the desired coordinate systems, can be established from a comparison between the established marker positions. A disadvantage of this method is that the sticky markers can slip and that only a few discrete points are acquired, and so only a small data pool is available for establishing a transformation prescription. Furthermore, the camera system in practice is often at a distance of one to two meters from the operation site, with care having to be taken that the direct connecting line between the markers and cameras is not interrupted. This leads to restrictions in the operation procedure.

In a known, alternative method, markers are fixed on the patient, for example screwed to a bone. A disadvantage of this method is that it requires an invasive intervention, which is uncomfortable for the patient.

U.S. Pat. Nos. 6,873,867 and 7,577,474 disclose the practice of scanning the surface of a body to be examined via a handheld laser, with the laser points being acquired by a 3D camera system. A topography of the surface is calculated from the established position of the laser points, which topography is compared to a data set obtained pre-surgery. Alternatively, a product distributed by Brainlab under the trade name Softtouch enables a topography to be determined with the aid of a scanning head, which is connected to the surface to be acquired and the position and orientation of which in space is once again established by a camera system when contact is made with the surface. A disadvantage of this method lies in the great time outlay for establishing the topography as a result of the sequential scanning of the surface. Moreover, these methods require a camera system for establishing the position of the laser points with the restrictions in the operation procedure connected therewith.

### SUMMARY OF THE INVENTION

It is an object of the invention to provide a method and an apparatus for determining a surface topography of a body in a coordinate system fixed in space and/or fixed on the body, which overcome the disadvantages of the aforementioned methods and apparatuses.

This object is achieved by a method which includes the following steps: recording a stereoscopic image of the surface of the body with an image recording device; and generating a topography data set from the stereoscopic image in a coordinate system connected to the image recording device. Here, a stereoscopic image should be understood to mean, for example, recordings which are recorded with the aid of two cameras or with one camera, which is moved in space, or with a 3D camera using the time-of-flight method. By using the stereoscopic image, a multiplicity of data points are available. The data points can be used via suitable methods at the same time for the generation of the topography data set. As a result, the time required for establishing a topography data set is reduced.

In one embodiment of the method, in a further method step, a position of the image recording device is established in a coordinate system that is fixed in space and/or fixed on the body. Here, the phrase “fixed on the body” relates to the body to be examined. This simplifies the comparison between the data established in the first step and in the second step, particularly if the body was moved therebetween or during the second step.

In a further embodiment of the method, at least one further stereoscopic image of the surface of the body is recorded by the image recording device from a perspective, which differs from the perspective when recording the first stereoscopic image, for the purposes of generating the topography data set. Consequently, a larger number of stereoscopic images, and therefore data points, are available, which can be used for generating the topography data set.

In a further embodiment of the method, a transformation prescription is determined between the coordinate system fixed in space, or the coordinate system fixed on the body, and the coordinate system connected to the image recording device and the topography data set is transformed into the coordinate system fixed in space or fixed on the body with the aid of the transformation prescription.

In a further embodiment of the method, a 3D camera is used as image recording device, which 3D camera can be held on a microscope, in particular a surgical microscope, or can be attached to such a microscope.

In a further embodiment of the method, the position of the image recording device in the coordinate system fixed in space is established with the aid of a navigation device arranged fixed in space, which navigation device is configured to determine the position of a marker arranged on the image recording device.

In a further embodiment of the method, a stereoscopic image of a marker arranged fixed in space or fixed on the body is recorded with the image recording device and the position of the image recording device in the coordinate system fixed in space or the coordinate system fixed on the body is established from the stereoscopic image of the marker arranged fixed in space or fixed on the body. This simplifies the establishment of the position of the image recording device relative to the body or the surrounding space, with it being possible to dispense with additional navigation devices in the surroundings of the body.

In a further embodiment of the method, the body is fixed relative to the marker arranged fixed in space.

In a further embodiment of the method, the topography data set from the stereoscopic image of the surface of the body is generated as a dense 3D reconstruction according to the method of optical flow or epipolar geometry or a sparse surface representation on the basis of node points with subsequent optimization of a cost function.

In a further embodiment of the method, the topography data set is generated as a depth map and/or a metrically correct topographic reconstruction, in particular as a mesh, grayscale image or point cloud.

In a further embodiment of the method, the topography data set is generated at least approximately in real-time by processing on one or more computers with a parallel computing structure.

In a further embodiment of the method, the topography data set and/or an established position of a marker arranged fixed in space is provided by way of an interface for use by other internal or external applications.

The object is further achieved by an apparatus for determining a surface topography of a body in a coordinate system fixed in space and/or a coordinate system fixed on the body. The apparatus includes a stereoscopic image recording device, which has a marker and which is configured for recording a stereoscopic image in a coordinate system fixed by the image recording device; a navigation device, which is configured to establish a position of the marker of the image recording device in the coordinate system fixed in space and/or the coordinate system fixed on the body; and a control unit, which is configured to generate a topography data set from the stereoscopic image in a coordinate system connected with the image recording device and determine a transformation prescription between the coordinate system fixed in space, or the coordinate system fixed on the body, and the coordinate system connected with the image recording device and transform the topography data set into the coordinate system fixed in space, or the coordinate system fixed on the body, with the aid of the transformation directive.

In an alternative embodiment of the invention, the apparatus for determining a surface topography of a body in a coordinate system fixed in space or a coordinate system fixed on the body includes a stereoscopic image recording device, which has a marker and which is configured to record a stereoscopic image in a coordinate system connected with the image recording device and establish a position in respect of the marker fixed in the coordinate system fixed in space or the coordinate system fixed on the body; and a control unit, which is configured to generate a topography data set from the stereoscopic image in a coordinate system connected with the image recording device and determine a transformation prescription between the coordinate system fixed in space, or the coordinate system fixed on the body, and the coordinate system connected with the image recording device and transform the topography data set into the coordinate system fixed in space, or the coordinate system fixed on the body, with the aid of the transformation prescription.

In one embodiment of the invention, the image recording device is embodied as a camera, in particular as a 3D camera.

In one embodiment of the invention, the image recording device is integrated in a microscope, in particular a surgical microscope, or connected to a microscope, in particular a surgical microscope.

### BRIEF DESCRIPTION OF THE DRAWING

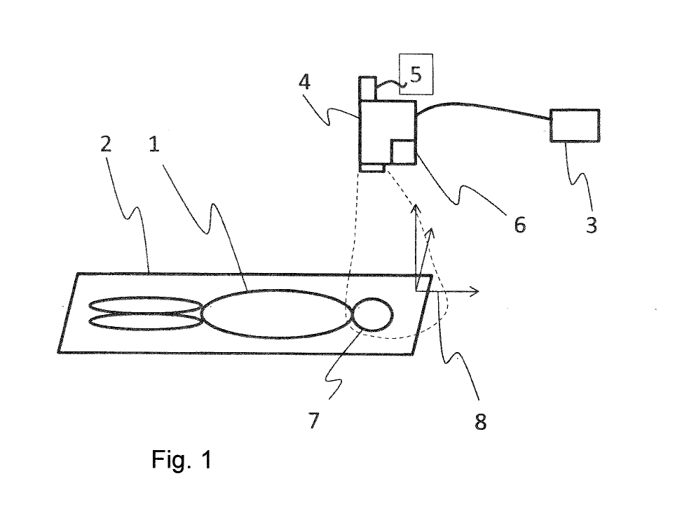

The invention will now be described with reference to the single FIGURE of the drawing (FIG. 1) which shows a surgical microscope and a patient being examined therewith.

### DESCRIPTION OF THE PREFERRED EMBODIMENTS OF THE INVENTION

In FIG. 1, a patient 1 is depicted lying on an operating table 2. In the lead up to the operation, medical data of the body part to be treated, in this embodiment, the head of the patient, were established using a medical device, for example, a computed tomography (CT) scanner or a magnetic resonance imaging (MRI) scanner, in a coordinate system fixed by the medical device. The medical data are stored in a computing unit 3.

During the operation, the data stored in the computing unit and established pre-surgery are intended to be brought into correspondence in terms of the spatial position and orientation thereof with data obtained during surgery. In this embodiment, the data obtained during surgery include a live image of the patient, recorded with the aid of a surgical microscope 4, onto which the CT or MRI data obtained pre-surgery are intended to be superposed. The surgical microscope 4 is held on a stand not shown in FIG. 1. The live image with the superposed data may be displayed on a screen or the data obtained pre-surgery are reflected into an observation beam path of the surgical microscope 4 such that live image and superposed data can be observed in an eyepiece 5 of the surgical microscope 4.

For the purposes of registration, a stereoscopic image of the head of the patient is recorded with an image recording device in the form of a stereo camera 6 that is integrated into the surgical microscope, from which stereoscopic image a topography data set is generated in a coordinate system fixed by the stereo camera. Here, the head 7 of the patient is fixed in relation to the operating table 2 via a stereotactic frame or another suitable apparatus. At the same time, the stereo camera 6 acquires a navigation point, for example in the form of a marker 8 at the stereotactic frame or at the operating table 2, which marker is visible in the image and the position of which is fixed relative to the examination location (the head of the patient). The provision of a fixed navigation point at the stereotactic frame or at the operating table provides the advantage of simplified navigation during the subsequent course of the operation when the body of the patient is, for example, covered by sterile towels.

A topographically dense reconstruction of the scene is established from the stereoscopic image. The reconstruction is preferably implemented in real-time by using a parallel architecture in the computing unit 3 or by parallel use of a plurality of computing units (cluster). To this end, the computing unit may, for example, include a multicore CPU or a suitable graphics processing unit (GPU) or may be configured as a field programmable gate array (FPGA).

The result of the reconstruction can be made available as a depth map and/or metrically correct topographic construction (mesh, grayscale image, point cloud).

The topographically dense reconstruction is subsequently compared to a topography of the surface of the head generated from the data established pre-surgery and brought into correspondence therewith. A transformation prescription for converting the data established pre-surgery into a coordinate system fixed on the body or fixed in space can be established from the comparison such that the data established pre-surgery can subsequently be superposed into a live image recorded during the operation and updated in the case of movements of the patient relative to the surgical microscope.

Preferably there is an automatic detection of the 3D position of the fixed navigation point relative to the topography of the body part to be examined.

By way of an interface, topography and 3D position of the fixed navigation point can be made available to further internal and/or external applications and/or stored for the subsequent course of the operation.

In a further embodiment, relatively large surfaces and/or volumes of the body part to be examined are acquired; this may also be implemented in a fully automated manner. To this end, the surgical microscope with the image recording device integrated therein or arranged thereon is preferably held on a robotic stand, that is, a stand with drive-assisted movement options. A plurality of positions are approached with the aid of the drives, at which positions stereoscopic recordings of the surface of the body, which ideally overlap, are recorded. There is a topographic reconstruction of the surface for each recording. By putting together the partial recordings (so-called “stitching”) via a combination of the intrinsic position information from the surgical microscope in a coordinate system fixed in space and/or fixed on the body (approximate initialization) and the image information from the stereoscopic recordings, it is possible to put together the topographic data obtained from the recordings so as to form a relatively large surface or a relatively large volume.

An in turn further embodiment enables a semi-automatic acquisition of relatively large surfaces or volumes. To this end, the surgical microscope with the image recording device integrated therein or arranged thereon is held on a stand with a pivot functionality. Here, a pivot functionality should be understood to mean a suitability of the stand for rotating the surgical microscope about a fixed point in space, wherein the fixed point always lies in an observation beam path of the surgical microscope. After recording a stereoscopic image, the microscope is aligned in such a way that a further recording can be made from a different perspective. This process can be implemented automatically by virtue of the surgical microscope automatically being displaced in an appropriate direction after the brakes of the surgical microscope are released. As soon as a distance to a target position drops below a threshold, the brakes are reactivated and a new stereoscopic recording is generated. This process is repeated until the whole desired area has been acquired.

In a further embodiment of the invention, the image recording device is equipped with a single camera. Without a patient movement and with a known change in position of the image recording device relative to the patient, a so-called structure-from-motion approach can also be selected for the topographic reconstruction.

It is understood that the foregoing description is that of the preferred embodiments of the invention and that various changes and modifications may be made thereto without departing from the spirit and scope of the invention as defined in the appended claims.

What is claimed is:

1. A method for determining a surface topography of a body, the method comprising the steps of:
recording a first stereoscopic image of the surface of the body with an image recording device;
generating a topographical data set from said first stereoscopic image in a first coordinate system set by the image recording device.

2. The method of claim 1 further comprising the step of:
determining a position of the image recording device in at least one of a second coordinate system fixed in space and a third coordinate system fixed to the body.

3. The method of claim 1, wherein the first stereoscopic image is recorded at a first viewing angle, the method further comprising the step of:
recording a second stereoscopic image of the surface of the body with the image recording device at a second viewing angle different from the first viewing angle; and,
wherein the topographical data set is generated in a coordinate system set by the image recording device from the first stereoscopic image and the second stereoscopic image.

4. The method of claim 2 further comprising the steps of:
determining a transformation directives between at least one of the second coordinate system and the third coordinate system and the first coordinate system set by the image recording device; and,
transforming the generated topographical data set into the second coordinate system with the determined transformation directives.

5. The method of claim 1, wherein the image recording device is a three dimensional camera.

6. The method of claim 2, wherein:
the position of the image recording device is determined in the second coordinate system;
the position of the image recording device in the second coordinate system is determined with a navigation apparatus arranged fixed in space;
the image recording device includes a marker arranged thereon; and,
the navigation apparatus is configured to determine the position of the marker arranged on the image recording device.

7. The method of claim 2 further comprising the step of:
recording a stereoscopic image of a marker arranged fixed in space or fixed on the body with the image recording device; and,
wherein the position of the image recording device in the coordinate system of the marker is determined from the stereoscopic image of the marker.

8. The method of claim 7, wherein the marker is fixed in space; and, the body is fixed with respect to the marker arranged fixed in space.

9. The method of claim 1, wherein the topographical data set is generated from the stereoscopic image of the surface of the body as a dense 3D reconstruction according to the method of optical flow or epipolar geometry or a sparse surface representation on the basis of node points with subsequent optimization of a cost function.

10. The method of claim 1, wherein the topographical data set is generated as a depth map and/or a metrically correct topographic reconstruction.

11. The method of claim 10, wherein the topographical data set is generated as a mesh, grayscale image or point cloud.

12. The method of claim 1, wherein the topography data set is generated at least approximately in real-time by processing on one or more computers with a parallel computing structure.

13. The method of claim 1, wherein the topography data set and/or an established position of a marker arranged fixed in space is provided by way of an interface for use by other internal or external applications.

14. An apparatus for determining a surface topography of a body in at least one of a first coordinate system fixed in space and a second coordinate system fixed to the body, the apparatus comprising:
a stereoscopic image recording device defining a third coordinate system for recording a stereoscopic image and having a marker;
said stereoscopic image recording device being configured to record the stereoscopic image in said third coordinate system fixed by said image recording device;
a navigation device configured to determine a position of said marker of said image recording device in at least one of the first coordinate system and the second coordinate system;
a control unit configured to generate a topographical data set from said stereoscopic image in said third coordinate system;
said control unit being further configured to determine a transformation directive between at least one of said first and said second coordinate systems and said third coordinate system; and,
said control unit being additionally configured to transform said topographical data set to at least one of said first and said second coordinate systems with said transformation directive.

15. The apparatus of claim 14, wherein said stereoscopic image recording device is a camera.

16. The apparatus of claim 14, wherein said stereoscopic image recording device is a 3D-camera.

17. The apparatus of claim 14, wherein said stereoscopic image recording device is integrated in a microscope or a surgical microscope.

18. The apparatus of claim 14, wherein said stereoscopic image recording device is connected to a microscope or a surgical microscope.

19. An apparatus for determining a surface topography of a body in a first coordinate system fixed in space or a second coordinate system fixed to the body, the apparatus comprising:
a stereoscopic image recording device having a third coordinate system associated therewith for recording a stereoscopic image and further having a marker;
said stereoscopic image recording device being configured to record a stereoscopic image in said third coordinate system and to determine a position of said marker with respect to the first or second coordinate system;
a control unit configured to generate a topographical data set from said stereoscopic image in said third coordinate system;
said control unit being further configured to determine a transformation directive between the at least one first and second coordinate systems and said third coordinate system; and,
said control unit being additionally configured to transform said topographical data set into at least one of said first and said second coordinate systems with said transformation directive.

20. The apparatus of claim 19, wherein said stereoscopic image recording device is a camera.

21. The apparatus of claim 19, wherein said stereoscopic image recording device is a 3D-camera.

22. The apparatus of claim 19, wherein said stereoscopic image recording device is integrated in a microscope or a surgical microscope.

23. The apparatus of claim 19, wherein said stereoscopic image recording device is connected to a microscope or a surgical microscope.
